(19) United States
(12) Patent Application Publication
(10) Pub. No.: US 2026/0330854 A1
(43) Pub. Date: Oct. 22, 2026

(54) INFORMATION PROCESSING APPARATUS, CONTROL METHOD THEREOF, AND STORAGE MEDIUM

(71) Applicant: CANON KABUSHIKI KAISHA, Tokyo (JP)

(72) Inventors: NOBUYUKI HORIE, Tokyo (JP); TAKAMITSU SENGOKU, Kanagawa (JP)

(21) Appl. No.: 19/577,932

(22) Filed: Mar. 25, 2026

(30) Foreign Application Priority Data
Apr. 16, 2025 (JP) 2025-067614

(51) Int. Cl. G06V 20/70; G06F 3/01; G06V 10/82

(52) U.S. Cl. CPC G06V 20/70; G06F 3/013; G06V 10/82; G06V 2201/07

(57) ABSTRACT

An information processing apparatus comprising: one or more memory devices that store a set of instructions; and one or more processors that execute the set of instructions to: use at least one of focus information of an object and line‑of‑sight information of a user with respect to the object displayed by an image capturing apparatus to output a subject of an image related to at least one of the object that is focused and the object toward which a degree to which the user directs his/her line of sight is a predetermined degree or more; and generate descriptive text of the image including an expression representing the subject that has been output.

### BACKGROUND

### Field of the Technology

The present disclosure relates to an information processing apparatus, a control method therefor, and a storage medium.

### Description of the Related Art

In recent years, generation of a summary (caption) of an image by a neural network has high generation accuracy, and has attracted attention as a method that can realize character search for an image. The higher the accuracy of caption generation is, the more the convenience of character search for an image is improved, and therefore caption generation techniques using various neural networks have been devised. For example, Japanese Patent Laid-Open No. 2020-13427 discloses a method for improving caption accuracy by extracting an overall characteristic and a partial characteristic from an image to specify an attention area from the two characteristics, and weighting the area. Japanese Patent Laid-Open No. 2017-142753 discloses a method for generating an appropriate number of tags by determining whether or not to tag according to a degree of blurring of an image, because excessive tagging degrades searchability.

When the technique according to Japanese Patent Laid-Open No. 2020-13427 is used, the attention area is specified from the characteristic of the image, and therefore a general-purpose attention area is selected. However, the selected attention area is not necessarily an area that the user intends to attach a caption. Therefore, there is a case of failing to attach a caption to the image as intended by the user. In such a case, the user cannot find the desired image even if performing character search, and as a result, convenience for the user is degraded. When the technique according to Japanese Patent Laid-Open No. 2017-142753 is used, an unnecessary tag is deleted, and therefore it is no longer possible to search a detailed situation in character search for the image. Also in such a case, there is a possibility that the user cannot find the desired image, and as a result, convenience for the user is degraded.

### SUMMARY

The present disclosure enables realization of a generation technique of descriptive text of an image that can improve accuracy in finding an image desired by a user.

One aspect of the present disclosure provides an information processing apparatus comprising: one or more memory devices that store a set of instructions; and one or more processors that execute the set of instructions to: use at least one of focus information of an object and line‑of‑sight information of a user with respect to the object displayed by an image capturing apparatus to output a subject of an image related to at least one of the object that is focused and the object toward which a degree to which the user directs his/her line of sight is a predetermined degree or more; and generate descriptive text of the image including an expression representing the subject that has been output.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a hardware configuration diagram of an image capturing apparatus according to one embodiment.

FIG. 2 is a functional block diagram of an image capturing apparatus according to one embodiment.

FIGS. 3A, 3B, and 3C are views illustrating captions according to one embodiment.

FIG. 4 is a flowchart of processing according to one embodiment.

FIG. 5 is a functional block diagram of an image capturing apparatus according to one embodiment.

FIG. 6 is a view illustrating a shot image according to one embodiment.

FIG. 7 is a flowchart of processing according to one embodiment.

FIG. 8 is a view illustrating a shot image according to one embodiment.

FIG. 9 is a hardware configuration diagram of an image capturing apparatus according to one embodiment.

FIG. 10 is a functional block diagram of an image capturing apparatus according to one embodiment.

FIGS. 11A, 11B, and 11C are views illustrating captions according to one embodiment.

FIG. 12 is an explanatory view of a heat map according to one embodiment.

FIG. 13 is an explanatory view of a heat map according to one embodiment.

FIG. 14 is a flowchart of processing according to one embodiment.

FIG. 15 is a flowchart of processing according to one embodiment.

FIG. 16 is a flowchart of processing according to one embodiment.

FIG. 17 is a view illustrating captions according to one embodiment.

FIG. 18 is a functional block diagram of an image capturing apparatus according to one embodiment.

FIG. 19 is an explanatory view of a heat map according to one embodiment.

FIG. 20 is an explanatory view of a heat map according to one embodiment.

FIG. 21 is a functional block diagram of an image capturing apparatus according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

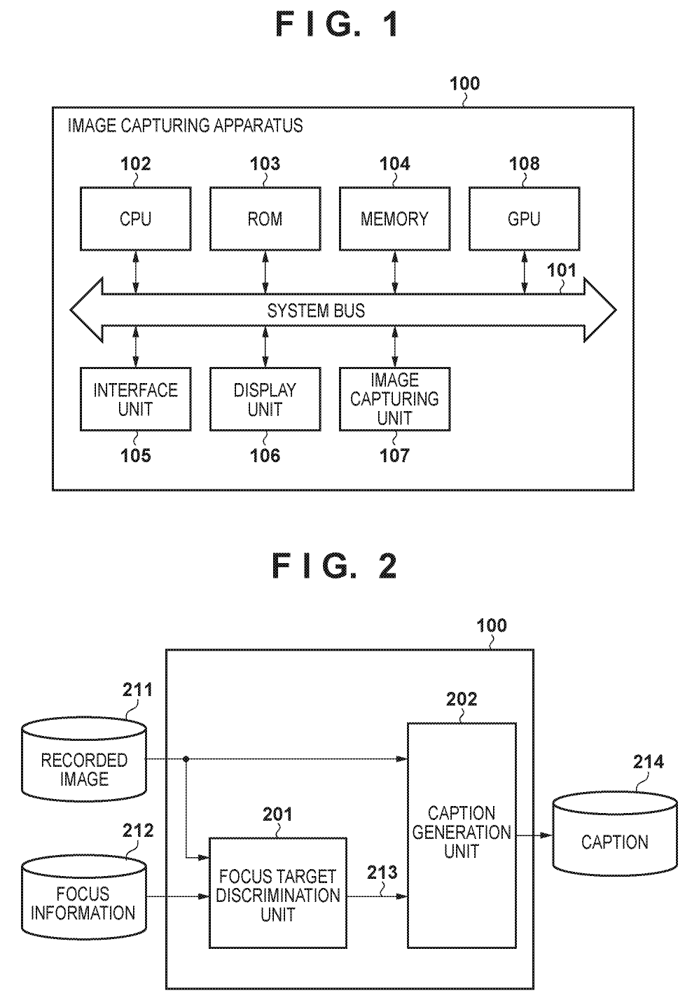

Hereinafter, an image capturing apparatus 100 according to a first embodiment will be described with reference to FIGS. 1-4. FIG. 1 exemplifies a hardware configuration of the image capturing apparatus 100. The image capturing apparatus 100 is configured to include a CPU 102, a ROM 103, a memory 104, an interface unit 105, a display unit 106, an image capturing unit 107, and a graphics processing unit (GPU) 108. These units are connected to one another via a system bus 101. That is, the units connected to the system bus 101 can exchange data with one another via the system bus 101. The image capturing apparatus 100 stores the image acquired by the image capturing unit 107 in a storage not illustrated in response to a user instruction obtained from the interface unit 105.

More specifically, the ROM 103 stores various programs for the CPU 102 to operate, parameters for realizing a learned neural network (learning model), and the like. Note that the storage destination of various programs for the CPU 102 to operate is not limited to the ROM, and may be, for example, a hard disk or the like. The memory 104 is configured to include, for example, a RAM. The CPU 102 or the GPU 108 uses the memory 104 as a work memory in accordance with a program stored in the ROM 103.

The interface unit 105 accepts a user operation and generates a control signal corresponding to the operation to supply it to the CPU 102. For example, the interface unit 105 includes a physical operation button and a touch panel as an input device that accepts a user operation. Note that the touch panel is an input device configured to output coordinate information corresponding to a position in contact with an input unit that is planarly configured, for example. The interface unit 105 includes a storage I/F that transmits and receives data to and from an external storage medium. The external storage medium is, for example, an SD card.

The CPU 102 controls each unit constituting the image capturing apparatus 100 as a whole. For example, using a control signal supplied according to the user operation accepted by the interface unit 105, the CPU 102 further controls the display unit 106 and the image capturing unit 107 in accordance with the program. This makes it possible to cause the display unit 106 and the image capturing unit 107 to perform an operation corresponding to the user operation.

The GPU 108 is a calculator that can perform processing specialized for calculation of computer graphics. In general, the GPU 108 can perform processing in a shorter time than the CPU 102 in a calculation required for a neural network such as matrix operation. As an alternative to the GPU 108, a neural processing unit (NPU) specialized by execution of learning and inference processing using a neural network may be provided.

The display unit 106 includes, for example, a display and a mechanism that outputs a display signal for causing the display to display an image. Note that in a case of using a touch panel as the interface unit 105, it is possible to integrally configure the interface unit 105 and the display. For example, the touch panel is configured so that light transmittance does not hinder display of the display, and is attached to an upper layer of a display surface of the display. Then, they can be configured by associating the input coordinate on the touch panel and the display coordinate on the display with each other.

The image capturing unit 107 is configured to include a lens, a shutter having an aperture function, and a CCD and a CMOS element that convert an optical image into an electric signal. The image capturing unit 107 is configured to further include an image processing unit that performs various types of image processing such as exposure control and distance measurement control using a signal output from an image capturing element, and performs a series of shooting processing. When the image capturing unit 107 is controlled by the CPU 102, shooting corresponding to a user operation of the interface unit 105 is possible.

The functional blocks of the image capturing apparatus 100 will be described with reference to FIG. 2. The image capturing apparatus 100 includes a focus target discrimination unit 201 (example of "output unit") and a caption generation unit 202 (example of "generation unit"). Note that the processing of the focus target discrimination unit 201 and the caption generation unit 202 is implemented by the CPU 102 or the GPU 108 executing a program.

The focus target discrimination unit 201 acquires a recorded image 211 shot in response to a shooting instruction signal from the interface unit 105 and stored in an external storage medium, and focus information 212 related to the acquisition timing thereof. Then, using the recorded image 211 and the focus information 212, the focus target discrimination unit 201 determines the subject information 213 to output it toward the caption generation unit 202. The subject information 213 may be, for example, information on a coordinate position of an area in a focused state in the recorded image 211, or may be a general-purpose name (e.g., a man, a child, a flower, or the like) of an object in a focused state. In a case where the object is registered in advance, it is also possible to output, as the subject information 213, information on the registered proper noun toward the caption generation unit 202.

Note that in the first embodiment, the processing of the focus target discrimination unit 201 is executed using, for example, a neural network. This neural network is a learned model learned in advance, for example, using image data and focus information for an object included in the image data as input data and the subject of the image as supervisory data. The focus target discrimination unit 201 inputs, as input data, the recorded image 211 and the focus information 212 to this neural network, and acquires the subject information 213 as output data.

Note that this neural network may be stored in advance in the image capturing apparatus 100, for example. Alternatively, the image capturing apparatus 100 may be configured to include a wireless module, and the neural network may be stored in a communicable external apparatus. Then, in the external apparatus, the recorded image 211 and the focus information 212 may be input to the neural network, and the image capturing apparatus 100 may receive the subject information 213 that is output.

As an alternative to the neural network, a known machine learning model may be adopted. As an alternative to the neural network, rule-based processing such as a lookup table (LUT) may be adopted. In the latter processing, for example, a relationship between the input data and the output data is created in advance as an LUT. Then, this created LUT may be stored in the memory 104. The focus target discrimination unit 201 can acquire data to be output toward the caption generation unit 202 with reference to this stored LUT. That is, the LUT is used as a program for performing processing equivalent to the former processing by the CPU, the GPU, and the like operating in cooperation.

The caption generation unit 202 generates a caption 214 for the recorded image 211 by using the recorded image 211 shot in response to the shooting instruction signal from the interface unit 105 and the subject information 213 output from the focus target discrimination unit 201. Note that the caption 214 is an example of "descriptive text". The caption generation unit 202 is, for example, a neural network. This neural network is a learned model learned in advance, for example, using image data and subject information as input data and a caption of an image as supervisory data. The caption generation unit 202 inputs, as input data, the recorded image 211 and the subject information 213 to this neural network, and acquires the caption 214 as output data.

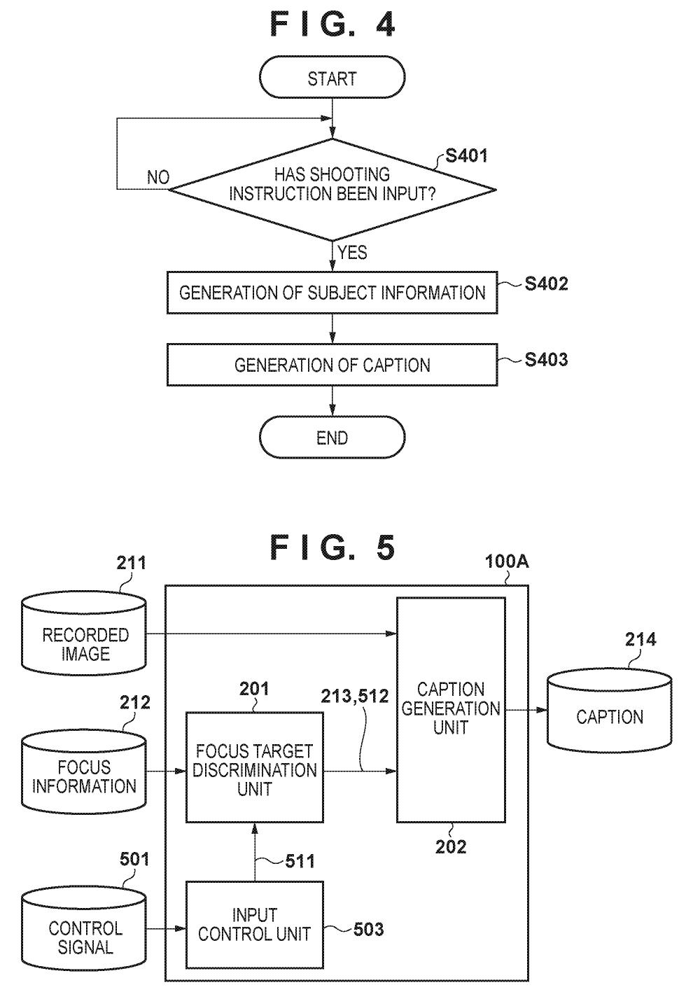

Note that this neural network may be stored in advance in the image capturing apparatus 100, for example. Alternatively, the image capturing apparatus 100 may be configured to include a wireless module, and the neural network may be stored in a communicable external apparatus. Then, in the external apparatus, the recorded image 211 and the subject information 213 may be input to the neural network, and the image capturing apparatus 100 may receive the caption 214 that is output. As an alternative to the neural network, a known machine learning model or rule-based processing such as a lookup table (LUT) may be adopted. Specific processing content of the focus target discrimination unit 201 and the caption generation unit 202 will be described later with reference to FIG. 4.

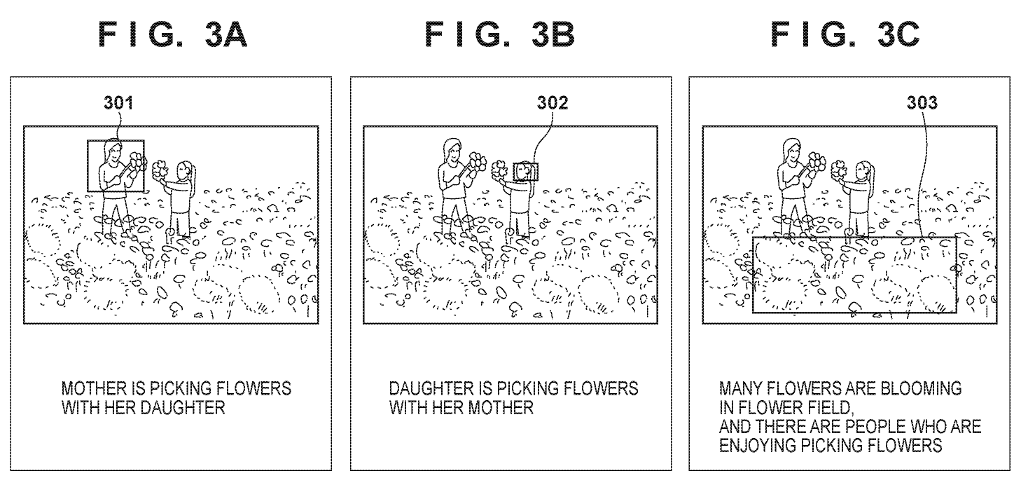

Here, the subject information 213, together with the recorded image 211, is input to the caption generation unit 202. Then, the caption generation unit 202 generates a caption for the recorded image 211 using these pieces of information. FIGS. 3A-3C exemplify a relationship among the recorded image 211, the focus information 212, and the caption 214. That is, FIG. 3A exemplifies a caption in a case where a focus target 301 is a mother (woman). FIG. 3B exemplifies a caption in a case where a focus target 302 is a daughter (child). FIG. 3C exemplifies a caption in a case where a focus target 303 is a flower field.

In the case of FIG. 3A, the focus target discrimination unit 201 determines that the focus target 301 is a mother. Then, the caption generation unit 202 generates a caption "mother is picking flowers with her daughter" (example of "expression representing the subject"), for example. Similarly, in the case of FIG. 3B, the caption generation unit 202 generates a caption "daughter is picking flowers with her mother", for example. In the case of FIG. 3C, the caption generation unit 202 generates a caption "Many flowers are blooming in a flower field, and there are people who enjoy picking flowers", for example.

In the caption generation method according to a comparative example, for example, caption generation is performed using one recorded image 211, but focus target information is not used. According to such a method according to the comparative example, it is difficult to uniquely determine the subject of the image even when the focus target information is different. Therefore, a caption that describes all of the mother, the daughter, and the flower field is generated. In such a case, even if the degree of detail in the caption description can be selected by the setting, whether to be the main object cannot be determined, and therefore a caption that describes an unnecessary part with respect to the intention of the user may be generated. Hence, when the user performs character search for an image, it is conceivable that an image other than the image actually desired by the user is also estimated to be the image desired by the user and is included in the search result. In such a case, search accuracy is degraded. For example, when the user performs character search for an image with the keyword of mother, the character of mother is included in the caption of an image in which the mother is not the focus target, and therefore this image may be included in the search result. Also in such a case, search accuracy is degraded.

On the other hand, according to the image capturing apparatus 100 according to the first embodiment, the focus target discrimination unit 201 determines the subject of the recorded image 211, and the caption generation unit 202 generates a sufficient caption of a part associated therewith, whereby it is possible to provide highly accurate character search for an image. Note that the caption accuracy improvement here does not indicate, for example, unnecessarily increasing the number of characters but indicates creating a sufficient caption intended by the user in order to improve the character search accuracy of the image.

By focusing on the focus target, the image capturing apparatus 100 can generate different captions as illustrated in FIGS. 3A-3C even for the same recorded image 211. The captions illustrated in FIGS. 3A-3C are examples. The caption may clarify the subject by focusing on the focus target, and the determined subject may serve as the subject of the caption text, or description of the subject may be given more (a large amount) and description other than the subject may be simplified (or omitted). If there is information registered in advance, the registered unique name (person's name or flower type) can be used. The information registered in advance may be stored in the memory 104, or may be acquired by accessing external information using a network function not illustrated. The determination of the subject is not limited to being performed by the focus target discrimination unit 201. The coordinate information of the recorded image 211 may be input to the caption generation unit 202, and the caption generation unit 202 may determine the subject of the recorded image 211 using this coordinate information.

A flowchart of operations of the focus target discrimination unit 201 and the caption generation unit 202 will be described with reference to FIG. 4. Note that the operation of each step in the flowchart of FIG. 4 is realized by each component of the image capturing apparatus 100 being controlled by the CPU 102 or the GPU 108 executing a program stored in the ROM 103.

In S401, the CPU 102 determines whether or not a shooting instruction has been input from the interface unit 105. Then, in a case where the CPU 102 determines that the shooting instruction has been input, the processing proceeds to S402, and otherwise, the processing of S401 is executed again.

In S402, upon receiving the shooting instruction from the CPU 102, the focus target discrimination unit 201 creates the subject information 213 using the recorded image acquired by the shooting instruction and the focus information 212 at the time of shooting of the recorded image. Then, the focus target discrimination unit 201 inputs the subject information 213 to the caption generation unit 202.

In S403, using the input recorded image and the subject information 213, the caption generation unit 202 generates and outputs a caption corresponding to the subject information 213 for the recorded image. Then, the processing ends.

Note that the image capturing apparatus 100 can be applied not only to a case where the recorded image is a still image but also a case where the recorded image is a moving image. In the case of a moving image, a recorded moving image is treated as a recorded image group, and focus information from the start of recording to the end of recording is treated as a focus information group. Therefore, upon receiving a shooting instruction, the focus target discrimination unit 201 determines the subject information 213 using the recorded moving image and the focus information group from the acquisition timing of the moving image to the end of shooting. Then, the caption generation unit 202 generates a caption for the recorded moving image with reference to the subject information 213. However, in the case of a moving image, the number of captions is not limited, and one caption may be generated for the entire moving image, or a caption may be generated for each frame of the moving image. A caption may be generated at each timing when the subject in the moving image changes.

### One Aspect of Actions and Effects

According to the image capturing apparatus 100 as described above, the focus target discrimination unit 201 generates the subject information 213 using the recorded image 211 and the focus information 212 related thereto. Then, the caption generation unit 202 generates a caption in accordance with the subject information 213. Therefore, the caption generation unit 202 can generate a caption that does not include an unnecessary part with respect to the intention of the user as much as possible. Hence, in a case where the user performs character search, it is possible to improve accuracy in finding a desired image.

### Second Embodiment

Hereinafter, content different from that of the first embodiment will be mainly described.

The functional blocks of an image capturing apparatus 100A according to a second embodiment will be described with reference to FIG. 5. The image capturing apparatus 100A includes functional blocks similar to the functional blocks of the image capturing apparatus 100 according to the first embodiment. Furthermore, the image capturing apparatus 100A includes an input control unit 503. Note that the processing of the input control unit 503 is realized by the CPU 102 or the GPU 108 executing a program.

The input control unit 503 receives a control signal 501 such as a non-recorded image, priority object information, line-of-sight sensor information, and shooting button information from the CPU 102. Then, the input control unit 503 executes a predetermined determination using the received control signal 501, and outputs a determination signal 511 indicating the determination result toward the focus target discrimination unit 201.

The focus target discrimination unit 201 generates the subject information 213 and reliability 512 of the subject information by using the determination signal 511 and the focus information 212. Then, the focus target discrimination unit 201 inputs the subject information 213 and the reliability 512 of the subject information to the caption generation unit 202. The caption generation unit 202 acquires the recorded image 211 stored in the external storage medium, and further acquires the subject information 213 and the reliability 512 of the subject information from the focus target discrimination unit 201 . Then, the caption generation unit 202 generates a caption for the recorded image 211 using the subject information 213 and the reliability 512 of the subject information.

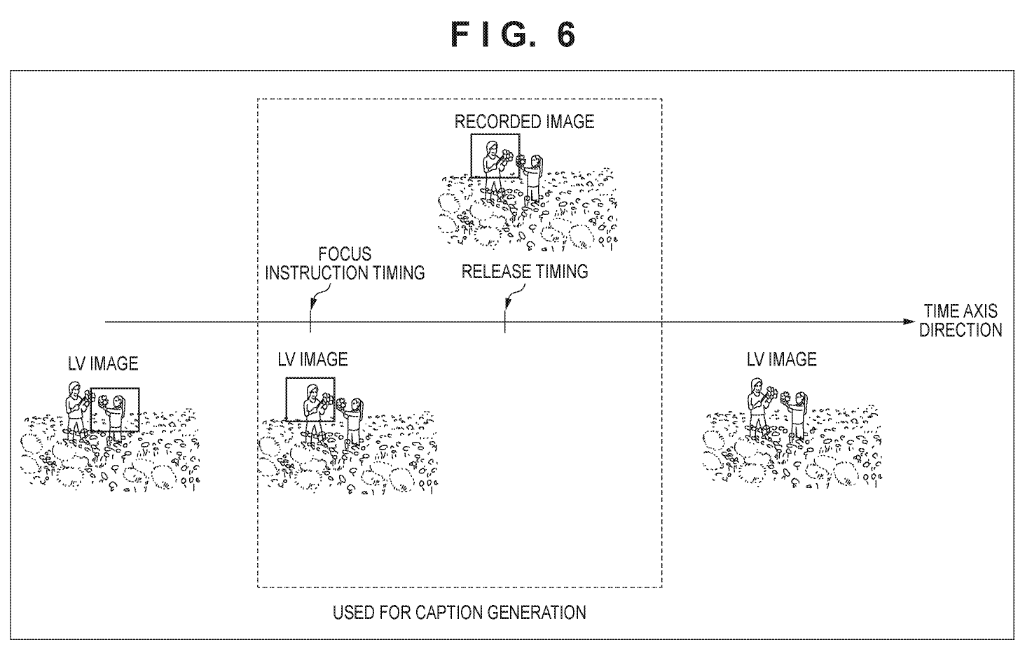

The recorded image 211, the focus information 212, a live view (LV) image, and the control signal 501 according to the second embodiment will be described with reference to FIG. 6. FIG. 6 illustrates a lapse of time in the left-right direction. The image capturing apparatus 100A acquires an LV image for displaying real-time image formation on the display unit 106 and one recorded image 211 shot in response to a shooting instruction of the user. Note that the focus information 212 is exemplified as a black frame in the recorded image 211. The focus information 212 used in the first embodiment is based on the shooting instruction in the present drawing.

A shooting button of the image capturing apparatus 100A according to the second embodiment is a switch that can input, to the CPU 102, two or more stages of user instructions such as unpressed, a focus instruction, and a shooting instruction in accordance with the degree of pressing, for example. Then, the control signal 501 is a signal indicating the degree of pressing of this control button, for example. The input control unit 503 receives the control signal 501 indicating that the shooting button is in a focus instruction state. Then, the input control unit 503 determines that the image capturing apparatus 100A is in a shooting preparation state by using the control signal 501.

Then, when the shooting button is further pressed from that state, the input control unit 503 receives the control signal 501 again. Then, the input control unit 503 determines that a shooting instruction has been given by using the control signal 501. In FIG. 6, the period of time surrounded by a dotted line indicates a period of time from the focus instruction to the shooting instruction. The input control unit 503 generates the determination signal 511 indicating that the focus information in this period of time is valid for the focus target discrimination unit 201, and outputs it toward the focus target discrimination unit 201.

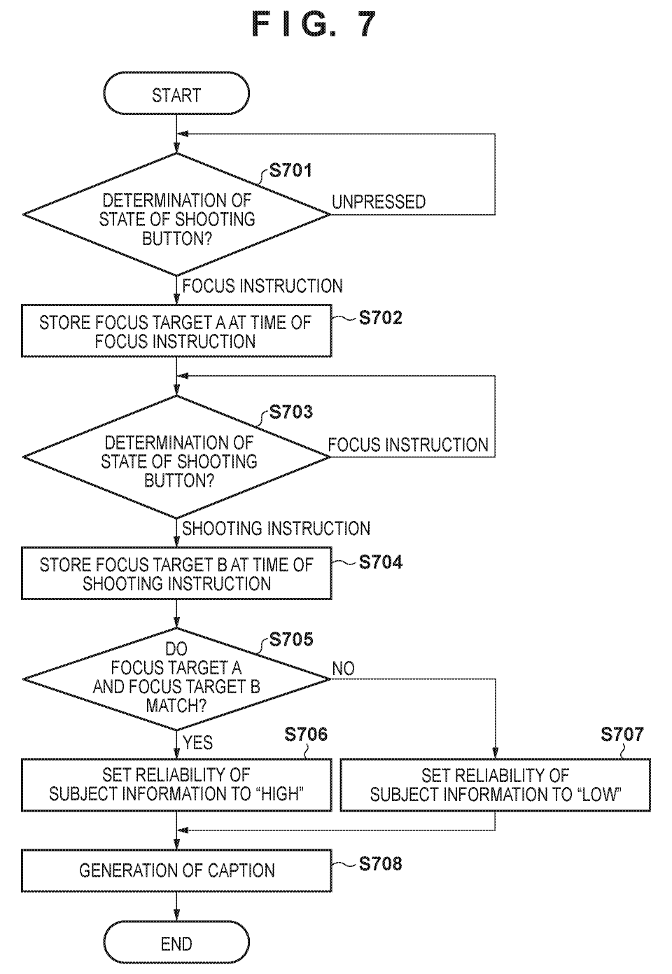

A method for determining the subject information 213 by the focus target discrimination unit 201 using the recorded image 211 and the valid period of time of the determination signal 511 will be described with reference to FIG. 7. That is, FIG. 7 exemplifies an operation flow of the focus target discrimination unit 201, the caption generation unit 202, and the input control unit 503. Here, as the control signal 501, it is assumed that the shooting button of the image capturing apparatus 100A described in FIG. 6 is a switch that can instruct states of two or more stages such as unpressed, a focus instruction, and a shooting instruction. Note that the operation of each step in the flowchart of FIG. 4 is realized by each component of the image capturing apparatus 100A being controlled by the CPU 102 or the GPU 108 executing a program stored in the ROM 103.

In S701, the input control unit 503 receives the control signal 501 indicating the state of the shooting button from the CPU 102. Then, the input control unit 503 determines the state of the shooting button by using the received control signal 501. Then, in a case of determining that the state of the shooting button is the focus instruction, the input control unit 503 outputs a determination signal to the focus target discrimination unit 201, and the processing proceeds to S702. On the other hand, in a case where the input control unit 503 determines unpressed, the processing returns to the beginning of S701. Note that here, it is assumed that the shooting instruction is always given after the focus instruction.

In S702, using the determination signal of the input control unit 503 in S701, the CPU 102 inputs, to the focus target discrimination unit 201, the focus information 212 during the focus instruction. The focus target discrimination unit 201 specifies a focus target A using the focus information 212 to store it in the memory 104.

In S703, the input control unit 503 receives the control signal 501 indicating the state of the shooting button from the CPU 102 again. Then, the input control unit 503 determines the state of the shooting button by using the received control signal 501. Then, in a case of determining that the state of the shooting button is the shooting instruction, the input control unit 503 outputs a determination signal to the focus target discrimination unit 201, and the processing proceeds to S704. On the other hand, in a case where the input control unit 503 determines a focus instruction, the processing returns to the beginning of S703.

Note that after the focus instruction, the shooting button may return to the unpressed state by the user releasing his/her finger from the shooting button. In such a case, although not illustrated in the present flow, it is assumed that the processing is performed again from S701. In a case where the input control unit 503 determines a focus instruction in S703, the processing returns to S702, and the CPU 102 may determine whether or not there is no change in the focus target A. In such a case, the focus target A is recorded as a focus group.

In S704, the CPU 102 inputs, to the focus target discrimination unit 201, the focus information 212 at the timing of the shooting instruction. The focus target discrimination unit 201 specifies and stores a focus target B using this focus information 212. In S705, the focus target discrimination unit 201 determines whether or not the focus target A and the focus target B match. Then, in a case where the focus target discrimination unit 201 determines that they match, the processing proceeds to S706, and otherwise, the processing proceeds to S707.

In S706, the focus target discrimination unit 201 sets focus information B as the subject information 213. The focus target discrimination unit 201 sets the reliability 512 of the subject information 213 to "high". Then, the focus target discrimination unit 201 outputs the subject information 213 and the reliability 512 toward the caption generation unit 202. Note that the focus target discrimination unit 201 may set the reliability 512 of the subject information 213 to a value equal to or more than a predetermined value in place of text information such as characters.

On the other hand, in S707, the focus target discrimination unit 201 sets the focus information B as the subject information 213, and sets the reliability 512 of the subject information to "low". Then, the focus target discrimination unit 201 outputs the subject information 213 and the reliability 512 toward the caption generation unit 202. Note that the focus target discrimination unit 201 may set the reliability 512 of the subject information 213 to a value equal to or more than a predetermined value in place of text information such as characters.

Note that in any of S706 and S707, the focus information B is set as the subject information 213, but the subject information 213 is not limited to the focus information B, and may be at least one piece of a plurality of pieces of focus information A and the focus information B. The focus information B may be output as the subject information 213, and the focus information A may be output as sub-information.

In S708, the caption generation unit 202 acquires the recorded image 211 stored in the external storage medium. Then, using the subject information 213 and the reliability 512 of the subject information input in S706 or S707, the caption generation unit 202 generates and outputs a caption to the recorded image 211. At this time, in a case where the subject information 213 and the reliability 512 thereof are input, the caption generation unit 202 creates a caption in more detail up to information other than the subject information as the reliability 512 is lower. On the other hand, as the reliability 512 is higher, the caption generation unit 202 creates a caption centered on the subject information 213 and more concise for information other than the subject information 213. Note that the caption generation unit 202 may recognize the level of the reliability 512 by decoding the character information of the reliability 512, or may recognize it by determining whether or not the reliability 512 is equal to or more than a predetermined value.

Note that the generation method for the caption is not limited to such an example. For example, in a case where a plurality of pieces of the subject information 213 are input to the caption generation unit 202, the caption generation unit 202 creates a caption for each of the plurality of pieces of subject information 213. In a case where sub-information is input in addition to the subject information 213, the caption generation unit 202 may generate a caption with the subject information 213 as a main description and the sub-information as a simple description. Then, the processing ends.

In the description of the second embodiment, a signal indicating the state of the shooting button is exemplified as the control signal 501 received by the input control unit 503, but the control signal 501 may be line-of-sight sensor information or object information. For example, the image capturing apparatus 100A is configured to include a line-of-sight sensor, and the input control unit 503 uses the line-of-sight sensor information as a control signal. In such a case, the input control unit 503 calculates the gaze level of the user at the time of image confirmation when the shot image after the shooting instruction is displayed on an electric view finder (EVF). Then, the focus target discrimination unit 201 determines whether or not the object having the highest gaze level is the focus information B when a shooting instruction is given to record an image. Then, in a case of determining that the object having the highest gaze level is the focus information B, the focus target discrimination unit 201 sets the reliability 512 of the subject information to "high", and otherwise, sets the reliability 512 of the subject information to "low".

In a case where the reliability 512 of the subject information is low, any of the object having the highest gaze level and the focus information B may be the subject information as described in S707, or one of them may be the subject information and the other may be the sub-information. Note that the calculation method for the gaze level is not limited to a specific method. For example, the gaze level of the object to which the line of sight is initially directed may be set to the highest value, or the gaze level of the object to which the line of sight is directed for the longest time may be set to the highest value.

In addition, in a case where the shooting target of the image capturing apparatus 100A is a priority object registered in advance, the control signal 501 can be a signal indicating whether or not the priority object is shot. In a case of determining that the priority object appears, the input control unit 503 outputs a determination signal indicating it toward the focus target discrimination unit 201. The focus target discrimination unit 201 receives this determination signal and determines whether or not the focus information B when a shooting instruction is given to record an image and the priority object are identical. Then, in a case of determining they are identical, the focus target discrimination unit 201 sets the reliability 512 of the subject information to "high". On the other hand, in a case where the focus information B and the priority object are different and the priority object is included in the recorded image 211, the focus target discrimination unit 201 sets the reliability 512 of the subject information to "low".

Here, an example in which the control signal 501 is the priority object information, the line-of-sight sensor information, or the shooting button information has been described, but the control signal 501 is not limited to the above example. The control signal 501 may be a combination of them, or other than them may be a control signal.

### One Aspect of Actions and Effects

As described above, according to the image capturing apparatus 100A according to the second embodiment, by determining the reliability of the focus information of the shot image, it is possible to generate a caption with high accuracy even in a case where the focus of the shot image is not necessarily as intended by the user. The high accuracy mentioned here indicates generating a caption that facilitates acquisition of an image desired by the user in character search for the image as described above. According to the image capturing apparatus 100A, the degree of caption generation related to information other than the subject can be adjusted in accordance with the reliability of the subject.

Note that in a case where the reliability of focus is low, more descriptions of caption are generated for information other than the subject, and therefore the possibility of being found by character search for the image is increased, but it will more frequently become a a search target. Therefore, image analysis may be combined with caption generation. That is, in a case where the focus target A, the gaze target, the priority object, or the like is obviously blurred, or in a case where the ratio to the image is smaller than a predetermined ratio, processing of removing it from the description of caption may be executed.

### Third Embodiment

Hereinafter, content different from those of the first embodiment and the second embodiment will be mainly described.

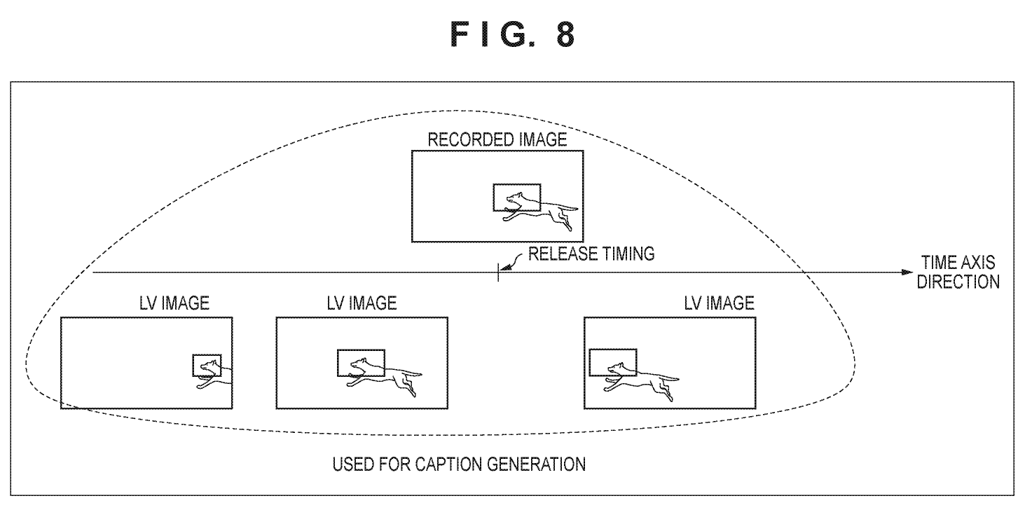

The recorded image 211, the focus information 212, and an LV image according to a third embodiment will be described with reference to FIG. 8. FIG. 8 illustrates a lapse of time in the left-right direction. An image capturing apparatus 100B according to the third embodiment acquires an LV image for displaying real-time image formation on the display unit 106 and one recorded image 211 shot in response to a shooting instruction of the user. In the third embodiment, the focus shift amount for a predetermined time before and after a shooting instruction is input to the focus target discrimination unit 201, whereby the focus target discrimination unit 201 outputs speed information of the focus target toward the caption generation unit 202. In FIG. 8, the period of time surrounded by a dotted line exemplifies a period of time in which the focus target discrimination unit 201 stores the focus shift amount in the memory 104 or the like.

In a case where the focus shift range in a predetermined period of time before and after the shooting instruction is small, the focus target discrimination unit 201 sets the speed information to "slow". Then, the focus target discrimination unit 201 outputs this speed information, together with the subject information 213, toward the caption generation unit 202. On the other hand, in a case where the focus shift range in the predetermined period of time before and after the shooting instruction is large, the focus target discrimination unit 201 sets the speed information to "fast".

Then, the focus target discrimination unit 201 outputs this speed information, together with the subject information 213, toward the caption generation unit 202. The caption generation unit 202 acquires the speed information of the subject information 213 using such focus shift information, thereby generating a caption including the speed of the subject information 213 from one recorded image 211.

Note that the speed information is not limited to "slow" and "fast", and may be set as accurate numerical information such as speed per hour. In this case, not simply the focus shift amount but the distance between the focus target and the image capturing apparatus 100B is determined by an infrared sensor or a phase difference sensor, and is calculated as speed information of the object. In order to calculate the focus shift amount, it is necessary to determine whether or not an identical object is being tracked. Therefore, the third embodiment can be applied to a case where an identical object is focused in a predetermined period of time before and after a shooting instruction.

### One Aspect of Actions and Effects

According to the third embodiment, since the information acquired for caption generation is speed information of the subject, it is possible to generate a highly accurate caption while suppressing an increase in processing load.

Note that the third embodiment can also be applied to a moving image. That is, the frame rate of the moving image is lowered when the caption is generated from a shot moving image. As described above, when creating a caption, the focus target discrimination unit 201 outputs this speed information, together with the subject information 213, toward the caption generation unit 202. In this manner, it is possible to generate a caption including speed information of the subject while suppressing an increase in processing load.

The frame rate of the moving image input at the time of caption generation may be adjusted using the speed information of the subject information 213. That is, the higher the speed information of the subject information 213 is, the higher the frame rate may be, and conversely, the lower the speed information of the subject information 213 is, the lower the frame rate may be. Also in this manner, it is possible to generate a caption of a moving image while suppressing an increase in processing load.

### Fourth Embodiment

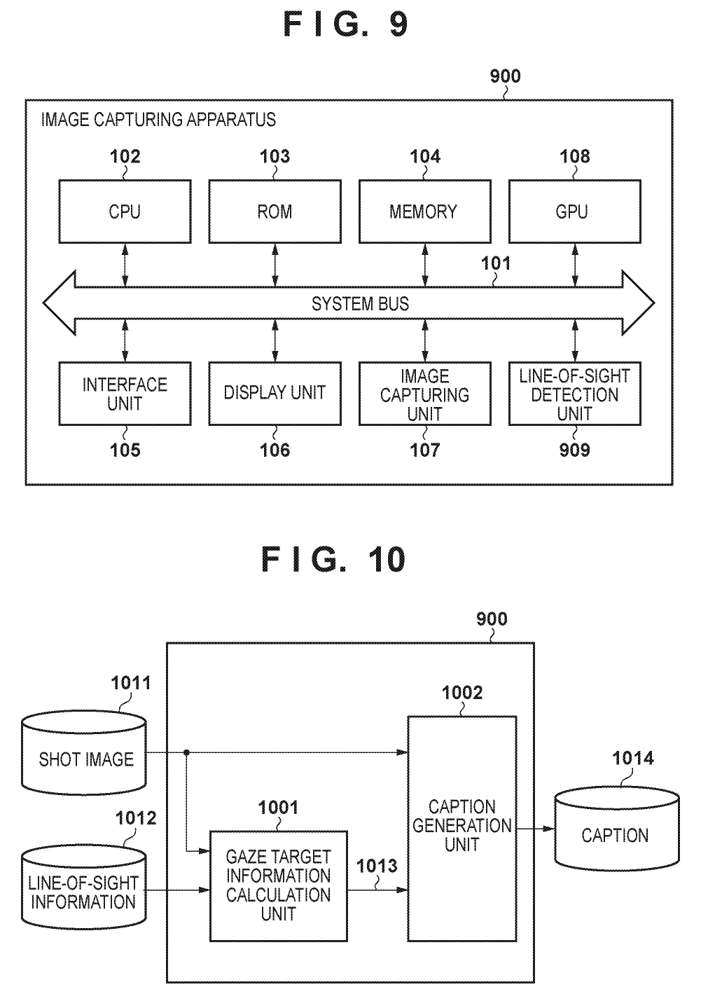

An image capturing apparatus 900 according to a fourth embodiment will be described with reference to FIGS. 9-17. FIG. 9 exemplifies a hardware configuration of the image capturing apparatus 900 according to the fourth embodiment. The image capturing apparatus 900 is configured to include a line-of-sight detection unit 909 in addition to the hardware configuration of the image capturing apparatus 100 according to the first embodiment illustrated in FIG. 1. The line-of-sight detection unit 909 includes a line-of-sight detector not illustrated that can detect the line of sight of the shooter. The line-of-sight detection unit 909 detects the line of sight of the shooter, and stores, for each unit time, information indicating whether or not the line of sight of the shooter is gazing at an image, a gaze position, and a gaze time (time when the gaze is detected). The storage destination is, for example, a register.

The functional blocks of the image capturing apparatus 900 will be described with reference to FIG. 10. The image capturing apparatus 900 includes a gaze target information calculation unit 1001 (example of "output unit") and a caption generation unit 1002 (example of "generation unit"). The processing of the gaze target information calculation unit 1001 and the caption generation unit 1002 is implemented by the CPU 102 or the GPU 108 executing a program.

The gaze target information calculation unit 1001 acquires a shot image 1011 shot by the image capturing unit 107 and line-of-sight information 1012 detected by the line-of-sight detection unit 909. Then, the gaze target information calculation unit 1001 generates subject information 1013 using these pieces of information to output it toward the caption generation unit 1002.

More specifically, the shot image 1011 is a moving image acquired from a shooting preparation stage, and is used for display of an electric view finder (EVF), for example. The CPU 102 stores, in a storage medium not illustrated, the shot image 1011 as a recorded video in response to a shooting instruction signal input from the interface unit 105 and indicating that the shooter has pressed the shutter button. The storage medium is, for example, an SD card.

For example, the caption generation unit 1002 acquires the recorded video in response to the shooting instruction signal, and generates a caption 1014 that describes the recording video. The caption generation unit 1002 stores the caption 1014 in the storage medium similarly to the recorded video. Note that the recorded video that is a caption generation target may be a moving image or a still image. The caption generation unit 1002 executes such processing using a neural network, for example.

This neural network is a learned model learned in advance, for example, using image data and subject information on this image as input data and a caption of the image as supervisory data. The caption generation unit 1002 inputs, as input data, the recorded video and the subject information 1013 to this neural network, and acquires the caption 1014 as output data.

Note that this neural network may be stored in advance in the memory 104 of the image capturing apparatus 100, for example. Alternatively, the image capturing apparatus 100 may be configured to include a wireless module, and the neural network may be stored in a communicable external apparatus. Then, in the external apparatus, the recorded video and subject information 1013 may be input to the neural network, and the image capturing apparatus 100 may receive the caption 1014 that is output.

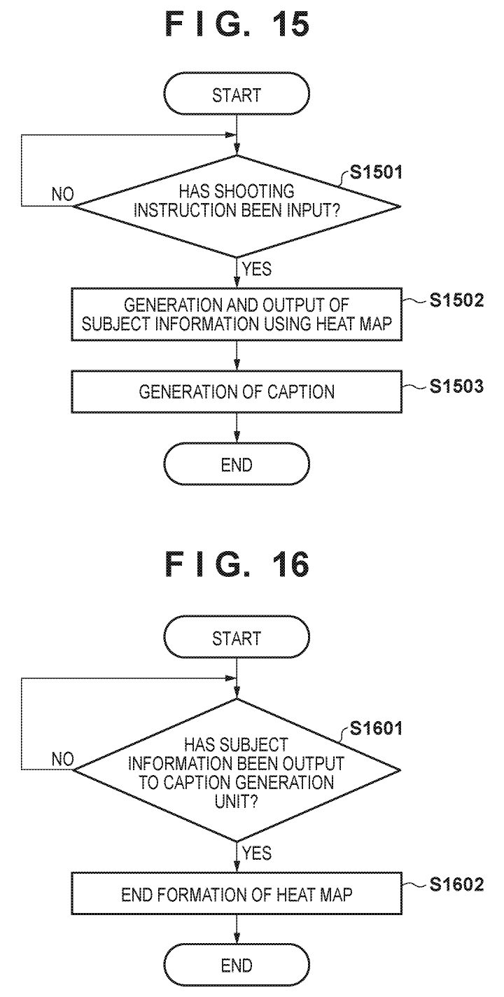

As an alternative to the neural network, a known machine learning model may be adopted. As an alternative to the neural network, rule-based processing such as a lookup table (LUT) may be adopted. Specific processing content of the gaze target information calculation unit 1001 and the caption generation unit 1002 will be described later with reference to FIG. 15.

The subject information 1013 includes, for example, in the shot image 1011, information representing whether or not an object is being gazed at, a coordinate position of a place being gazed at, and an attention degree of the place. Specific content of the attention degree will be described later. The coordinate position being gazed at may be replaced with a general-purpose name (e.g., a man, a child, a flower, or the like) of the object being gazed at. In the case of an object registered in advance, the gaze target information calculation unit 1001 may output the registered proper noun toward the caption generation unit 1002. Note that the attention degree is an example of "degree to which the user directs his/her line of sight is a predetermined degree or more".

In the fourth embodiment, a heat map (example of "density map") is used to handle the attention degree. The heat map is generated by the gaze target information calculation unit 1001. More specifically, a value in which the number of times the line of sight is directed using the line-of-sight information 1012 is integrated with time at all coordinate points of the shot image 1011 is the attention degree. The gaze target information calculation unit 1001 forms a heat map by plotting this attention degree on all coordinate points of the shot image 1011 and coloring the coordinate plane in accordance with the value thereof. In the present example, the higher the attention degree is, the lower the brightness of the color (darker color) used for coloring is. Hereinafter, the degree of density of the color of the heat map is also referred to as attention degree.

The processing of associating the coordinate position of the shot image 1011 with the name of the object, and identifying the area of a specific object, or the processing of associating the heat map with the area of the object in the shot image, and the like are executed using a neural network.

This neural network is a learned model learned in advance, for example, using a coordinate position of an object included in an image as input data and an object name or a specific object area as supervisory data. The gaze target information calculation unit 1001 inputs, as input data, the coordinate position of the shot image 1011 to this neural network, and acquires the name of the object or the area of the specific object as output data. Alternatively, this neural network is a learned model learned in advance, for example, using density information of a heat map as input data and an area of the object in the shot image 1011 as supervisory data. The gaze target information calculation unit 1001 inputs, as input data, the density information of the heat map to this neural network, and acquires the area of the object in the shot image 1011 as output data.

Note that this neural network may be stored in advance in the memory 104 of the image capturing apparatus 100, for example. Alternatively, the image capturing apparatus 100 may be configured to include a wireless module, and the neural network may be stored in a communicable external apparatus. Then, in the external apparatus, the recorded video and subject information 1013 may be input to the neural network, and the image capturing apparatus 100 may receive the caption 1014 that is output.

As an alternative to the neural network, a known machine learning model may be adopted. Such processing may also be executed using a rule base such as a lookup table (LUT). In that case, for example, a relationship between the input data and the output data is created in advance as an LUT. Then, this created LUT is stored in the memory 104. The gaze target information calculation unit 1001 can acquire data to be output to the caption generation unit 1002 with reference to this stored LUT. That is, the LUT is used as a program for performing processing equivalent to the former processing by the CPU, the GPU, and the like operating in cooperation.

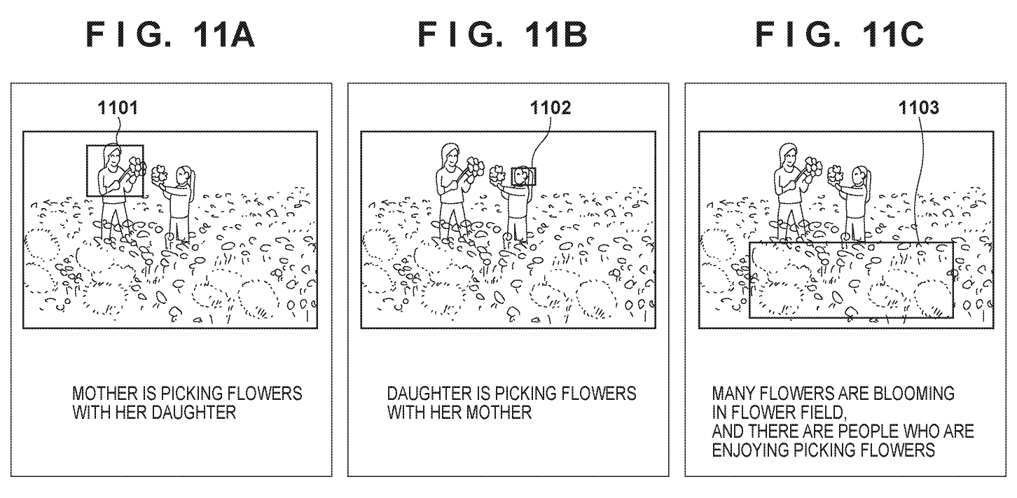

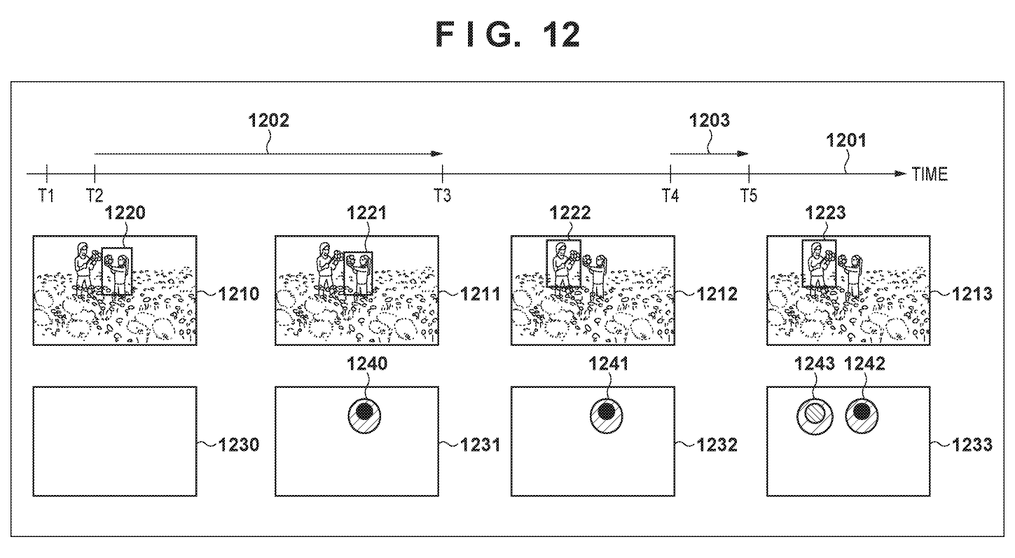

Here, the subject information 1013, together with the shot image 1011, is input to the caption generation unit 1002. Then, the caption generation unit 1002 generates a caption of the recorded video acquired from the shot image 1011. A relationship among the recorded video, the line-of-sight information 1012, and the caption 1014 according to the fourth embodiment will be described with reference to FIGS. 11A-11C. FIG. 11A exemplifies a caption in a case where a gaze target 1101 is a mother, FIG. 11B exemplifies a caption in a case where a gaze target 1102 is a daughter, and FIG. 11C exemplifies a caption in a case where a gaze target 1103 is a flower field.

In the case of FIG. 11A, the gaze target information calculation unit 1001 determines that the gaze target 1101 is the mother. Then, the caption generation unit 1002 generates a caption "mother is picking flowers with her daughter". In the case of FIG. 11B, the caption generation unit 1002 generates a caption "daughter is picking flowers with her mother". In the case of FIG. 11C, the caption generation unit 1002 generates a caption "Many flowers are blooming in a flower field, and there are people who enjoy picking flowers".

In the caption generation method according to the comparative example, for example, caption generation is performed using one recorded video, but gaze information of a shooter is not used. According to a method according to such the comparative example, in a case where gaze targets (1101, 1102, and 1103) are different as illustrated in FIGS. 11A to 11C, it is difficult to uniquely determine the subject of the image. Therefore, a caption that describes all of the mother, the daughter, and the flower field is generated. In such a case, even if the degree of detail in the caption description can be selected by the setting, whether to be the main object cannot be determined, and therefore a caption that describes an unnecessary part with respect to the intention of the user may be generated. Hence, when the user performs character search for an image, it is conceivable that an image other than the image actually desired by the user is also estimated to be the image desired by the user and is included in the search result. In such a case, search accuracy is degraded. For example, when the user performs character search for an image with the keyword of mother, the character of mother is included in the caption of an image in which the mother is not the gaze target or the gaze target itself is not present, and therefore this image may be included in the search result. Also in such a case, search accuracy is degraded.

On the other hand, according to the image capturing apparatus 900 according to the fourth embodiment, the caption generation unit 202 determines the subject of the recorded image 211 and generates a sufficient caption of a part associated therewith, whereby it is possible to accurately perform character search for the image. Note that the caption accuracy improvement here does not indicate, for example, unnecessarily increasing the number of characters but indicates creating a sufficient caption intended by the user in order to improve the character search accuracy of the image.

That is, by focusing on the gaze information of the shooter, the image capturing apparatus 900 can generate different captions as illustrated in FIGS. 11A-11C even for a similar recorded video. The caption illustrated in each of FIGS. 11A-11C is an example. The caption is not limited to the examples of FIGS. 11A-11C, and the subject of the caption may be clarified by focusing on the gaze position of the shooter. For example, the determined subject may serve as the subject of the caption text, or information other than the subject may be described in accordance with the attention degree. If there is information registered in advance, the registered unique name (person's name or flower type) can be used. The information registered in advance may be stored in the memory 104, or may be acquired by accessing external information using a network function not illustrated. The determination of the subject is not limited to being performed by the gaze target information calculation unit 1001. The coordinate information of the shot image 1011 may be input to the caption generation unit 202, and the caption generation unit 202 may determine the subject using this coordinate information.

A formation process of the heat map will be described with reference to FIG. 12. FIG. 12 is an example in which the process of forming the heat map using the shot image 1011 and the line-of-sight information 1012 is described in time series by plotting the time from T1 to T5 on a time axis 1201. Images 1210 to 1213 are the shot images 1011 at times T2, T3, T4, and T5, respectively. Heat maps 1230 to 1233 correspond to the images 1210 to 1213, respectively.

The heat map 1230 at and before time T2 is in an initial state. The value of the attention degree is 0 over the entire coordinate plane, and the color representing this state is white as illustrated in the heat map 1230. Note that here, an area having a high attention degree is represented by low brightness, and an area having a low attention degree is represented by high brightness.

Time T1 is a time at which the shooter starts directing his/her line of sight to a daughter 1220 with respect to the image 1210 displayed on the EVF. At this time, the line‑of‑sight information 1012 is, for example, "Time T1. Line of sight present. (40, 15)". ‎ ‎ "Time T1" is a time at which the line‑of‑sight information 1012 is acquired. "Line of sight present" indicates that the shooter is gazing at the image. "(40, 15)" indicates a coordinate position on the shot image plane to which the line of sight is directed, and is a coordinate value of the inside or the vicinity of the daughter 1220. Using this coordinate value and object identification processing of the image 1210, the gaze target information calculation unit 1001 recognizes that the shooter is looking at the daughter 1220. The object identification processing is, for example, processing by a neural network.

This neural network is a learned model learned in advance, for example, using image data as input data and object information included in an image as supervisory data. The caption generation unit 1002 inputs, as input data, the image 1210 to this neural network, and acquires object information as output data.

Note that this neural network may be stored in advance in the memory 104 of the image capturing apparatus 100, for example. Alternatively, the image capturing apparatus 100 may be configured to include a wireless module, and the neural network may be stored in a communicable external apparatus. Then, in the external apparatus, the image 1210 may be input to the neural network, and the image capturing apparatus 100 may receive the object information (daughter 1220) that is output.

As an alternative to the neural network, a known machine learning model may be adopted. As an alternative to the neural network, rule-based processing such as a lookup table (LUT) may be adopted.

Time T2 is a time at which formation of the heat map is started when a period of time during which the shooter continues his/her line of sight to a daughter 1221 in the image 1210 at and after time T1 reaches a predetermined time (= time T2 - time T1). Note that also at and after time T1, the line-of-sight information 1012 including "line of sight present" is periodically generated and input to the gaze target information calculation unit 1001 while the line of sight to the daughter 1221 is continued.

Time T3 is a time at which the shooter stops continuing the gaze at the daughter 1221. A time 1202 in which time T2 is subtracted from time T3 is a time during which the shooter keeps gazing at the daughter 1220. A heat map 1231 representing the attention degree at the time 1202 includes a gray zone 1240 representing that the attention degree at the position of the daughter 1221 is high. The heat map is also formed at and after time T3 and at and before time T4. However, there is no change in the heat map at the time when no line of sight is detected with respect to the image 1210.

The line‑of‑sight information 1012 generated at time T4 is, for example, "Time T4. Line of sight present. (20, 10)", indicating that the line of sight is directed to a mother 1222. ‎ ‎ The shooter is gazing at a mother 1223 until time T5. The attention degree to the mother 1223 at time T5 is represented by a gray zone 1243. Since a time 1203 during which the mother 1223 is gazed at is shorter than the time during which the daughter 1221 is gazed at, the gray zone 1243 is formed to be lighter than a gray zone 1242. That is, the heat map is formed so that it becomes clear that the attention degree of the shooter is greater to the daughter 1221 than to the mother 1223.

Here, the attention degree when the gaze is continued is a value in which the number of times line of sight is directed per unit time is counted as one time and the number of times of attention per unit time is integrated with time. Then, in a case where shooting is performed at time T5, the gaze target information calculation unit 1001 generates the subject information 1013 using the heat map 1233 to output it toward the caption generation unit 1002. At this time, the formation of the heat map ends and is initialized.

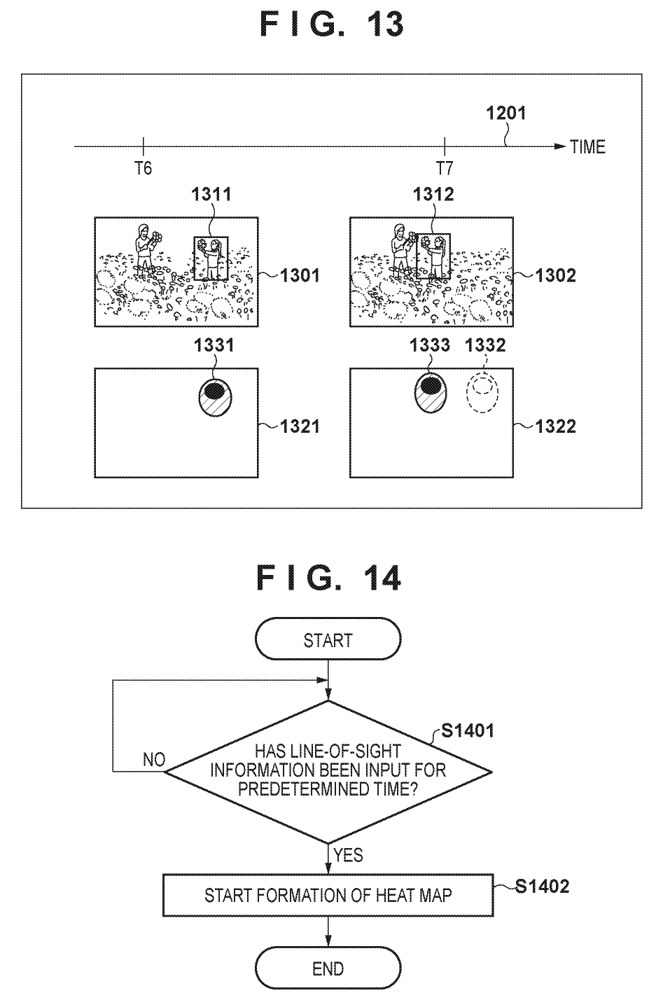

A heat map tracking a motion of the object will be described with reference to FIG. 13. An image 1301 and an image 1302 exemplify the shot images 1011 at time T6 and time T7, respectively. At time T6, the attention degree to the daughter existing at a position 1311 is acquired as a gray zone 1331 of a heat map 1321. When the daughter moves from the position 1311 to a position 1312 closer to the mother from time T6 to time T7, a gray zone 1332 at time T6 moves to a gray zone 1333 in response to the movement of the daughter. This can be performed by associating the gray zone with the area of the daughter identified as an object.

A flowchart for starting formation of a heat map will be described with reference to FIG. 14. Note that the operation of each step in the flowchart of FIG. 14 is realized by each component of the image capturing apparatus 100A being controlled by the CPU 102 or the GPU 108 executing a program stored in the ROM 103.

In S1401, the gaze target information calculation unit 1001 waits for input of the line-of-sight information 1012 including "line of sight present". Thereafter, the gaze target information calculation unit 1001 determines whether or not the line-of-sight information including "line of sight present" has been continuously input for a predetermined time. Then, in a case where the gaze target information calculation unit 1001 determines that this line-of-sight information has been input for a predetermined time, the processing proceeds to S1402, and otherwise, the processing of S1401 is executed again from the beginning.

In S1402, the gaze target information calculation unit 1001 starts formation of a heat map. Then, the processing ends. However, the flowchart of FIG. 14 is an example of formation start processing of the heat map, and the determination processing whether or not the line-of-sight information has been input in S1401 is not limited to the above. For example, the gaze target information calculation unit 1001 may determine whether or not a value of a signal input by the user or a value corresponding to an output value of a sensor becomes a predetermined value. The gaze target information calculation unit 1001 may initialize the heat map at an initial stage of the start of heat map creation.

A flowchart for forming a caption in the fourth embodiment will be described with reference to FIG. 15. Note that the operation of each step in the flowchart of FIG. 15 is realized by each component of the image capturing apparatus 100A being controlled by the CPU 102 or the GPU 108 executing a program stored in the ROM 103.

In S1501, the CPU 102 determines whether or not a shooting instruction has been input from the interface unit 105. Then, in a case where the CPU 102 determines that the shooting instruction has been input, the processing proceeds to S1502, and otherwise, the processing returns to the beginning of S1501.

In S1502, upon receiving the shooting instruction from the CPU 102, the gaze target information calculation unit 1001 creates the subject information 1013 using the recorded video (shot image 1011) and the heat map at the time of the shooting instruction and outputs it toward the caption generation unit 1002.

In S1503, the caption generation unit 1002 acquires the recorded video. The caption generation unit 1002 acquires the subject information 1013 from the gaze target information calculation unit 1001. Then, the caption generation unit 1002 generates and outputs a caption corresponding to the subject information 213 for the recorded video. Then, the processing ends.

A flowchart for ending the formation of the heat map will be described with reference to FIG. 16. Note that the operation of each step in the flowchart of FIG. 16 is realized by each component of the image capturing apparatus 100A being controlled by the CPU 102 or the GPU 108 executing a program stored in the ROM 103.

In S1601, the CPU 102 determines whether or not the gaze target information calculation unit 1001 has output the subject information 1013 toward the caption generation unit 1002. Then, in a case where the CPU 102 determines that the subject information 1013 has been output, the processing proceeds to S1602, and otherwise, the processing returns to the beginning of S1601. In S1602, the gaze target information calculation unit 1001 ends the formation of the heat map and initializes the heat map. Then, the processing ends.

However, the flowchart of FIG. 16 is an example, and for example, the determination content of S1601 is not limited to the above. In S1601, by determining whether or not a value of a signal input by the user or a value corresponding to an output value of a sensor becomes a predetermined value, the CPU 102 may detect that the subject information has been output toward the caption generation unit.

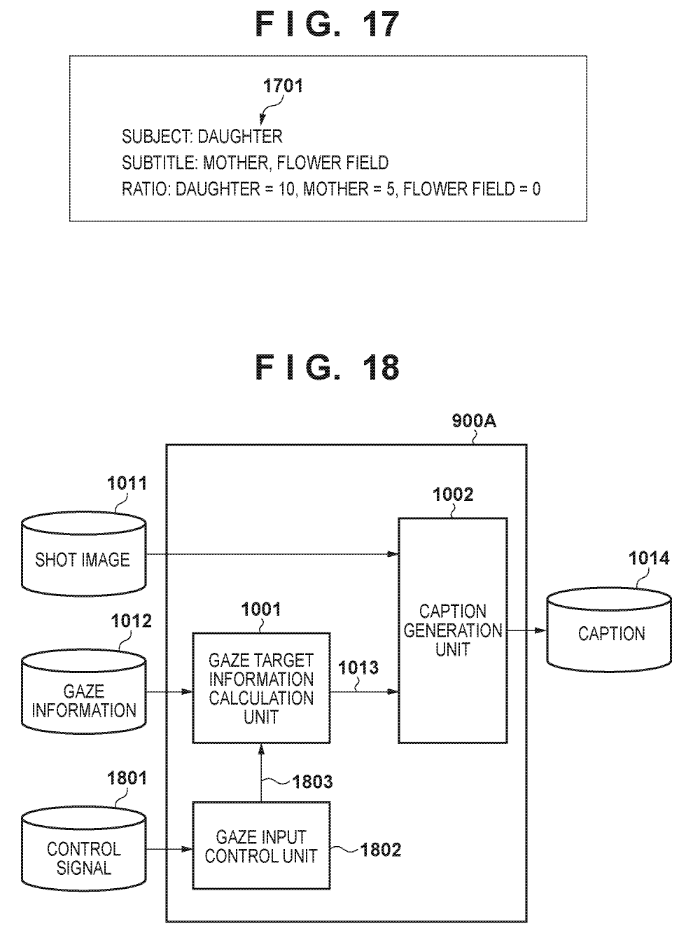

An example 1701 of the subject information 1013 according to the fourth embodiment will be described with reference to FIG. 17. The example 1701 includes a subject and a subtitle. That is, the gaze target information calculation unit 1001 sets the subject to "daughter" and the subtitles to "mother" and "flower field", respectively, in accordance with the attention degree. The subject information 1013 includes instruction information on a caption generation ratio corresponding to the attention degree. Here, it is assumed that the attention degrees are "daughter", "mother", and "flower field" in descending order. At this time, since the attention degree of "daughter" is the highest, the instruction information on the caption generation ratio includes an instruction to generate the most detailed caption, with the ratio of caption generation of "daughter" being 10, which is the highest. The instruction information includes an instruction to set the ratio of caption generation of "mother" to 5. The instruction information includes an instruction to set the generation ratio of "flower field" to 0, that is, the ratio of the subject or the subtitle of the caption to 0. This is an instruction that a caption with "flower field" as the subject or the subtitle should not be generated. Note that the caption generation ratio is, for example, a ratio of the amount of the number of characters of the caption.

### One Aspect of Actions and Effects

According to the image capturing apparatus 900 according to the fourth embodiment, the caption generation unit 1002 generates a caption by referring to the recorded video acquired from the shot image 1011 and the subject information 1013. This subject information 1013 is created by the gaze target information calculation unit 1001 using the line‑of‑sight information 1012. Hence, it is possible to generate a caption with high accuracy.

### Fifth Embodiment

In a fifth embodiment, since subject information is generated using a heat map similarly to the fourth embodiment, content different from that of the fourth embodiment will be mainly described.

The functional blocks of an image capturing apparatus 900A according to the fifth embodiment will be described with reference to FIG. 18. The image capturing apparatus 900A includes the functional blocks of the image capturing apparatus 900 according to the fourth embodiment. In addition, the image capturing apparatus 900A includes a gaze input control unit 1802. Note that the processing of the gaze input control unit 1802 is realized by a program being operated by the CPU 102 or the GPU 108.

The gaze input control unit 1802 receives a control signal 1801 such as priority object information, shooting button information, and a mode setting value from the CPU 102. Then, the gaze input control unit 1802 generates a determination signal 1803 (details will be described later) using the control signal 1801 to output it toward the gaze target information calculation unit 1001. Using the determination signal 1803 and the line-of-sight information 1012, the gaze target information calculation unit 1001 generates the subject information 1013 to output it toward the caption generation unit 1002. The caption generation unit 1002 generates a caption for the recorded video by using the acquired recorded video (shot image 1011) and the subject information 1013.

FIG. 19 exemplifies control of the integral coefficient of the heat map according to the fifth embodiment. Images 1901 and 1902 exemplify the shot images 1011 at times T8 and T9, respectively. A heat map 1921 corresponds to the image 1901. As indicated by the heat map 1921, heat map formation is started before time T8, and it is a state where a gray zone 1933 is formed at time T8.

A heat map 1922 is a heat map obtained at time T9 in a case where the shooter does not touch the shooting button from time T8 to time T9. On the other hand, a heat map 1923 is a heat map obtained at time T9 in a case where the shooter half-presses the shooting button from time T8 to time T9. A gray zone 1935 of the heat map 1923 is darker in color than a gray zone 1934 of the heat map 1922. That is, the line‑of‑sight information in a case where the shooting button is half-pressed is reflected more strongly than the line‑of‑sight information in a case where the shooting button is not touched.

The signal propagation and the calculation at this time will be described. The shooting button information indicating whether or not the shooting button is half-pressed is input to the gaze input control unit 1802 as the control signal 1801. Then, the gaze input control unit 1802 outputs this control signal 1801 as the determination signal 1803 toward the gaze target information calculation unit 1001. Then, the gaze target information calculation unit 1001 changes the coefficient when integrating the number of times of gaze with time in accordance with the determination signal 1803. For example, the gaze target information calculation unit 1001 sets the coefficient in a case where the shooting button is half-pressed to be larger than the coefficient in a case where the shooting button is not touched.

In this manner, it is possible to provide a difference in the integral value (attention degree) between the case where the shooting button is half-pressed and the case where the shooting button is not touched at the same time (time from T8 to T9). Note that in FIG. 19, the half-pressing of the shooting button has been described as an example, but the control signal 1801 is not limited to a signal indicating the half-pressing operation of the shooting button, and may be another control signal.

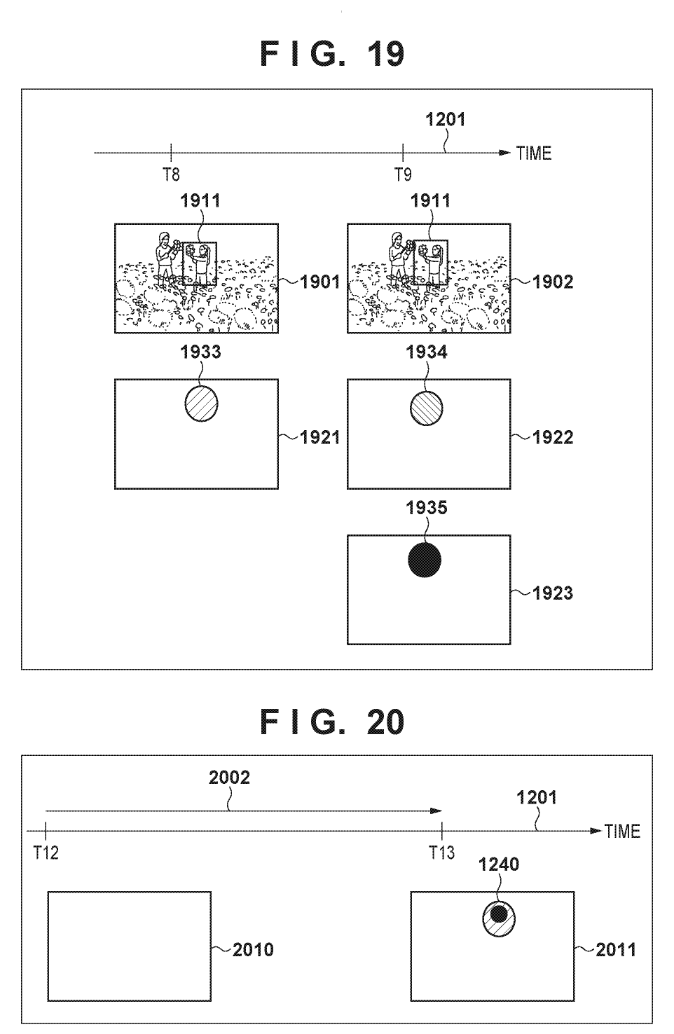

An example of start and end of formation of the heat map according to the fifth embodiment will be described with reference to FIG. 20. Time T12 is a time at which a sensor value included in the control signal 1801 is input to the gaze input control unit 1802 and the time-series pattern of the sensor value matches a predetermined pattern A. At this time, the formation of the heat map is started. A heat map 2010 at time T12 exemplifies an initial state.

Time T13 is a time at which the time-series pattern of the sensor value matches a predetermined pattern B. At this time, the formation of the heat map is ended. The gray zone 1240 formed by the shooter gazing at a time 2002 from time T12 to time T13 is recorded in a heat map 2011. Similarly, the heat map may be initialized when the sensor value matches a predetermined pattern C. Here, the sensor is a sensor that detects the motion of the shooter. That is, the sensor is an image capturing sensor that shoots, for example, the shooter’s blinking or the eye movement.

Here, the start and end timings of the heat map of FIG. 20 in the fifth embodiment and the start and end timings of the heat maps of FIGS. 12, 14, and 16 in the fourth embodiment can be switched and used by a mode setting signal. For example, when the mode setting value included in the control signal 1801 is 0, the start and end timings of the heat map can be the timings described with reference to FIGS. 12, 14, and 16. On the other hand, when the mode setting value is 1, the start and end timings of the heat map can be the timings described with reference to FIG. 20. An example in which the value of the sensor that detects the motion of the shooter is used to start and end the formation of the heat map has been described, but the control signal used to start and end the formation of the heat map is not limited to them, and may be another control signal.

In the above description, the shooting button and the sensor information are exemplified as the control signal 1801 to be received by the gaze input control unit 1802, but the object information can also be used as the control signal. In a case where the shooting target of the image capturing apparatus 900 is a priority object registered in advance, the control signal 1801 can be a signal indicating whether or not the priority object is shot. In a case of determining that the priority object appears, the gaze input control unit 1802 outputs the determination signal 1803 indicating it toward the gaze target information calculation unit 1001. In such a case, the gaze target information calculation unit 1001 changes the coefficient at the time of integration to a larger value in the area related to the priority object of the heat map.

Here, an example in which the control signal 1801 is the priority object information, the user setting information, or the shooting button information has been described, but the control signal 1801 is not limited to the above example. The control signal 1801 may be a combination of them, or other than them may be the control signal 1801.

### One Aspect of Actions and Effects

According to the image capturing apparatus 900A according to the fifth embodiment, by changing the coefficient for integrating the number of times of gaze with time in accordance with the determination signal 1803, it is possible to generate a caption with higher accuracy aligned with the intention of the user as compared with the image capturing apparatus 900 according to the fourth embodiment.

### Sixth Embodiment

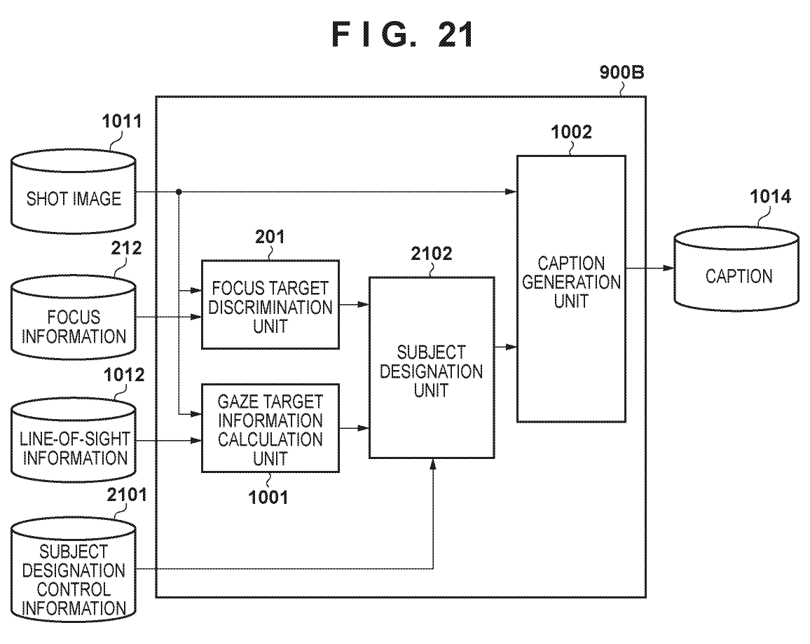

The functional blocks of an image capturing apparatus 900B according to a sixth embodiment will be described with reference to FIG. 21. Note that hereinafter, different parts from those of the first embodiment and the fifth embodiment will be mainly described.

The image capturing apparatus 900B includes the focus target discrimination unit 201 of the image capturing apparatus 100 according to the first embodiment, and the gaze target information calculation unit 1001 and the caption generation unit 1002 of the image capturing apparatus 900A according to the fifth embodiment. In addition, the image capturing apparatus 900B includes a subject designation unit 2102. The subject designation unit 2102 acquires the output of the focus target discrimination unit 201 and the output of the gaze target information calculation unit 1001. Then, the subject designation unit 2102 processes those outputs in accordance with subject designation control information 2101 to generate the subject information 1013. Then, the subject designation unit 2102 outputs this subject information 1013 toward the caption generation unit 1002.

Here, the content of processing executed by the subject designation unit 2102 may be selecting either the output of the focus target discrimination unit 201 or the output of the gaze target information calculation unit 1001, or may be integrating the two outputs based on some rule. For example, when the subject designation control information 2101 includes a shooting mode signal of "caption generation by focus", the subject designation unit 2102 outputs the output of the focus target discrimination unit 201 as the subject information 1013 toward the caption generation unit 1002. In such a case, the weight between the focus information and the line‑of‑sight information for caption generation is 1:0.

Alternatively, as another example, when the subject designation control information 2101 includes a shooting mode signal of "caption generation by focus and line of sight. Weight 2:1.", the subject designation unit 2102 executes the following processing. ‎That is, the subject designation unit 2102 multiplies each of the output of the focus target discrimination unit 201 and the output of the gaze target information calculation unit 1001 by a weight of 2:1 and adds the weighted outputs to designate the subject information 1013. Alternatively, as another example, it is assumed that the output of the focus target discrimination unit 201 is "daughter" and the output of the gaze target information calculation unit 1001 is "mother = 10". In such a case, the subject designation unit 2102 designates the subject information 1013 such as "subject: daughter", "subtitle: mother", and "ratio: daughter = 10, mother = 5".

### One Aspect of Actions and Effects

According to the image capturing apparatus 900B according to the sixth embodiment, the focus information 212 according to the first to third embodiments and the line‑of‑sight information 1012 according to the fourth and fifth embodiments are selected or combined and used. Hence, it is possible to generate a caption with high accuracy aligned with the intention of the user.

### Modification

The functional blocks of the image capturing apparatus 100 may be provided in an external server such as a cloud server, for example. More specifically, the image capturing apparatus 100 is configured to include a communication module, and transmits the captured image and the focus information 212 to the external server via a network. In the external server, a caption is generated as in the above embodiments. Then, the image capturing apparatus 100 may acquire the generated caption via the network.

FIG. 2 and the like describe that the recorded image 211, the focus information 212, the caption 214, and the like are stored in a storage medium outside the image capturing apparatus 100, but these pieces of information may be stored in the memory 104 or the like included in the image capturing apparatus 100. The target to be generated by the caption generation unit 202 is not limited to captions as long as the target describes the content of the image.

The gaze refers to that the shooter has continuously directed his/her line of sight to a predetermined area of the image for a predetermined time or more. This predetermined time can be set arbitrarily. For example, the predetermined time may be set to 0. In such a case, the gaze refers to a case where the shooter simply directs his/her line of sight to a predetermined area of the image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-067614, filed Apr. 16, 2025, which is hereby incorporated by reference herein in its entirety.

What is claimed is:

1. An information processing apparatus comprising:
one or more memory devices that store a set of instructions; and
one or more processors that execute the set of instructions to:
use at least one of focus information of an object and line‑of‑sight information of a user with respect to the object displayed by an image capturing apparatus to output a subject of an image related to at least one of the object that is focused and the object toward which a degree to which the user directs his/her line of sight is a predetermined degree or more; and
generate descriptive text of the image including an expression representing the subject that has been output.

2. The information processing apparatus according to claim 1, wherein
the line‑of‑sight information includes information indicating detection of the line of sight with respect to the object displayed by the image capturing apparatus, a position of the object, and time when the line of sight is detected.

3. The information processing apparatus according to claim 1, wherein
the one or more processors further execute instructions in the one or more memory devices to:
output reliability of the focus information or the line‑of‑sight information; and
use the reliability that is output, in order to generate the descriptive text.

4. The information processing apparatus according to claim 3, wherein
the one or more processors execute instructions in the one or more memory devices to:
use information indicating a state of a shooting button of the image capturing apparatus, a degree to which the user directs his/her line of sight toward the object included in an image displayed on an EVF of the image capturing apparatus, or a shooting target designated in advance, in order to output the reliability.

5. The information processing apparatus according to claim 4, wherein
the information indicating the state of the shooting button includes information of a focus instruction for the object and a shooting instruction for the object, and wherein
the one or more processors execute instructions in the one or more memory devices to:
output a higher reliability in a case where a focus target when the user instructs focus and a focus target when the user instructs shooting match than in a case where the focus target when the user instructs focus and the focus target when the user instructs shooting do not match.

6. The information processing apparatus according to claim 4, wherein
the one or more processors execute instructions in the one or more memory devices to:
output a higher reliability in a case where a focus target when the user instructs shooting and a target toward which the user directs his/her line of sight with respect to the image displayed on the EVF match than in a case where the focus target when the user instructs shooting and the target toward which the user directs his/her line of sight with respect to the image displayed on the EVF do not match.

7. The information processing apparatus according to claim 4, wherein
the one or more processors execute instructions in the one or more memory devices to:
output a higher reliability in a case where a focus target when the user instructs shooting and a shooting target designated in advance match than in a case where the focus target when the user instructs shooting and the shooting target designated in advance do not match.

8. The information processing apparatus according to claim 3, wherein
the one or more processors execute instructions in the one or more memory devices to:
generate the descriptive text with a larger amount of explanation of the subject in a case where the reliability is high than in a case where the reliability is low.

9. The information processing apparatus according to claim 1, wherein
the descriptive text includes speed information on the subject in a predetermined period of time before and after a shooting timing of the image.

10. The information processing apparatus according to claim 1, wherein
the one or more processors execute instructions in the one or more memory devices to:
generate a density map according to an area and time at which the user directs his/her line of sight, in order to output the subject.

11. The information processing apparatus according to claim 10, wherein
the one or more processors execute instructions in the one or more memory devices to:
generate the density map using the focus information.

12. The information processing apparatus according to claim 10, wherein
the one or more processors further execute instructions in the one or more memory devices to:
execute determination for starting and ending creation of the density map.

13. The information processing apparatus according to claim 12, wherein
the determination includes
a first determination as to whether or not the line of sight of the user has been directed for a predetermined time to the image displayed on the EVF of the image capturing apparatus, and
a second determination as to whether or not the subject has been output, and wherein
the one or more processors execute instructions in the one or more memory devices to:
start creation of the density map in a case where a result of the first determination is that the line of sight of the user has been directed for the predetermined time to the image displayed on the EVF, and
end creation of the density map in a case where a result of the second determination is that the subject has been output.

14. The information processing apparatus according to claim 13, wherein
the determination includes
a third determination as to whether or not an output value of a sensor that has detected eye motion when the user shoots the object matches a first pattern, and
a fourth determination as to whether or not the output value of the sensor matches a second pattern, and wherein
the one or more processors execute instructions in the one or more memory devices to:
start creation of the density map in a case where a result of the third determination is that the output value matches the first pattern, and
end creation of the density map in a case where a result of the fourth determination is that the output value matches the second pattern.

15. The information processing apparatus according to claim 14, wherein
the one or more processors execute instructions in the one or more memory devices to:
switch and execute the first determination and the second determination, and the third determination and the fourth determination.

16. The information processing apparatus according to claim 1, wherein
the one or more processors further execute instructions in the one or more memory devices to:
output a subtitle of the image and a ratio between an amount of an expression representing the subject and an amount of an expression representing the subtitle in the descriptive text.

17. The information processing apparatus according to claim 1, wherein
the one or more processors execute instructions in the one or more memory devices to:
weight and use the focus information and the line‑of‑sight information, in order to output the subject.

18. The information processing apparatus according to claim 1, wherein
the information processing apparatus includes the image capturing apparatus.

19. A control method for an information processing apparatus, the control method comprising:
using at least one of focus information of an object and line‑of‑sight information of a user with respect to the object displayed by an image capturing apparatus to output a subject of an image related to at least one of the object that is focused and the object toward which a degree to which the user directs his/her line of sight is a predetermined degree or more; and
generating descriptive text of the image including an expression representing the subject that has been output.

20. A non-transitory computer-readable storage medium storing a computer program for causing a computer to execute each step in a control method for an information processing apparatus, the control method comprising:
using at least one of focus information of an object and line‑of‑sight information of a user with respect to the object displayed by an image capturing apparatus to output a subject of an image related to at least one of the object that is focused and the object toward which a degree to which the user directs his/her line of sight is a predetermined degree or more; and
generating descriptive text of the image including an expression representing the subject that has been output.
